(19) United States
(12) Patent Application Publication
(10) Pub. No.: US 2017/0127447 A1
(43) Pub. Date: May 4, 2017

(54) STATION (STA) AND METHOD FOR CONTENTION BASED NEIGHBORHOOD AWARENESS NETWORK (NAN) COMMUNICATION

(71) Applicants: Po-Kai Huang, West Lafayette, IN (US); Emily H. Qi, Portland, OR (US); Elad Oren, Tel Aviv (IL)

(72) Inventors: Po-Kai Huang, West Lafayette, IN (US); Emily H. Qi, Portland, OR (US); Elad Oren, Tel Aviv (IL)

(21) Appl. No.: 15/082,129

(22) Filed: Mar. 28, 2016

Related U.S. Application Data
(60) Provisional application No. 62/249,562, filed on Nov. 2, 2015.

(51) Int. Cl. H04W 74/08

(52) U.S. Cl. CPC H04W 74/0816; H04W 84/12

(57) ABSTRACT

Embodiments of a station (STA) and method for contention based communication are generally described herein. As part of a Neighborhood Awareness Network (NAN) communication, an originating STA may perform a group of one or more data transmissions to a destination STA during a current time block. The data transmissions may be performed in accordance with a NAN Data Link (NDL) between the originating STA and the destination STA. An initial data transmission of the group may be delayed, with respect to a determined idle period of the current time block, by a back-off interval selected in accordance with a starting contention window (CW) size. In some embodiments, the starting CW size may be based at least partly on a previous CW size used by the originating STA for a data transmission during a previous time block.

### PRIORITY CLAIM

This application claims priority under 35 USC 119(e) to U.S. Provisional Patent Application Ser. No. 62/249,562, filed Nov. 2, 2015 [reference number P92504Z (4884.396PRV)] which is incorporated herein by reference in its entirety.

### TECHNICAL FIELD

Embodiments pertain to wireless networks. Some embodiments relate to wireless local area networks (WLANs) and Wi-Fi networks including networks operating in accordance with the IEEE 802.11 family of standards. Some embodiments relate to direct communication between mobile devices, including communication using Wi-Fi Aware techniques and/or Neighborhood Awareness Network (NAN) techniques. Some embodiments relate to contention based communication.

### BACKGROUND

Mobile devices may communicate with a base station of a mobile network to exchange data, voice and other information. In some cases, it may be beneficial for a mobile device to communicate directly with other mobile devices. For instance, two mobile devices located in close proximity may communicate over a direct wireless link between the two devices. Such communication in device-to-device scenarios and other scenarios may be challenging, in some cases, and therefore there is a general need for methods and systems that address these scenarios.

### BRIEF DESCRIPTION OF THE DRAWINGS

FIG. 1 illustrates a wireless network in accordance with some embodiments;

FIG. 2 illustrates an example machine in accordance with some embodiments;

FIG. 3 illustrates a station (STA) in accordance with some embodiments;

FIG. 4 illustrates the operation of a method of communication in accordance with some embodiments; and

FIG. 5 illustrates an example of a schedule of time blocks in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

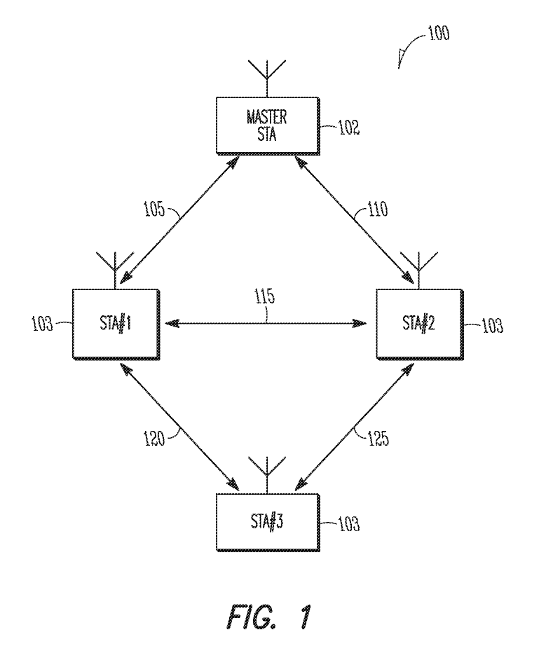

FIG. 1 illustrates a wireless network in accordance with some embodiments. In some embodiments, the network 100 may be a Wireless Local Area Network (WLAN) or a Wi-Fi network, although the scope of embodiments is not limited in this respect. It should be noted that embodiments are not limited to the number or type of components shown in the example network 100. Embodiments are also not limited by the example network 100 in terms of the arrangement of the components or the connectivity between components as shown. In addition, some embodiments may include additional components.

The example network 100 may include one or more master stations (STAs) 102 and/or one or more stations (STAs) 103. In some embodiments, the master STAs 102 and/or STAs 103 may be arranged to operate in accordance with one or more IEEE 802.11 standards. It should be noted that some embodiments may not necessarily include a master STA 102. In addition, in some embodiments, an STA 103 may be configurable to operate as a master STA 102 and/or as an STA 103. These embodiments are not limiting, however, as other mobile devices, portable devices and/or other devices, which may or may not be arranged to operate in accordance with a standard, may be used in some embodiments. As an example, a User Equipment (UE) arranged to operate in accordance with one or more Third Generation Partnership Project (3GPP) standards may be used in some cases.

In the example network 100, the STAs 103 may be configured to communicate with the master STA 102 and/or with other STAs 103. As shown in FIG. 1, STA #1 may communicate with the master STA 102 over the wireless link 105, STA #2 may communicate with the master STA 102 over the wireless link 110, and STA #1 and STA #2 may communicate directly with each other over the wireless link 115. In some embodiments, the communication between the master STA 102 and the STAs 103 and/or the communication between the STAs 103 may be performed using any suitable 802.11 standard (including legacy 802.11 standards). Such communication may also be performed in accordance with one or more Wi-Fi Aware and/or Neighborhood Awareness Network (NAN) standards, in some embodiments. These embodiments are not limiting, however, as other communication techniques and/or protocols may be used for the communication between the master STA 102 and the STAs 103 and/or the communication between the STAs 103, in some embodiments.

In accordance with some embodiments, STA #1 may transmit a data signal to STA #2 during a NAN time block of a sequence of NAN time blocks allocated for NAN communication between a group of STAs 103 that includes STA #1 and STA #2. For instance, the NAN communication may include communication over a NAN Data Link (NDL) between STA #1 and STA #2. The transmission of the data signal may be performed in accordance with contention based access techniques, in some cases. These embodiments will be described in more detail below.

As a non-limiting example, two STAs 103 may communicate with each other although both may not necessarily communicate with the same master STA 102. For instance, one of the STAs 103 may be out of range of the master STA 102, and in some cases, may communicate with a different master STA 102. Referring to FIG. 1, STA #3 may communicate with STAs #1 and #2 over wireless links 120 and 125, despite being out of range of the master STA 102 (at least temporarily).

In some embodiments, the master STA 102 may perform one or more operations as part of a NAN communication, such as exchanging of control messages with the STAs 103 for an establishment of the NAN communication, providing a reference timing for the NAN communication and/or other management/control operations. However, embodiments are not limited to usage of a master STA 102 in the NAN communication, as NAN communication between STAs 103 may be performed with little or no involvement of the master STA 102. For instance, one of the STAs 103 may transmit synchronization signals to enable other STAs 103 to establish a common synchronization/timing, in some embodiments.

In some embodiments, the STAs 103 may be arranged to operate in accordance with a protocol and/or standard such as Wi-Fi Aware, NAN, Wi-Fi Aware 2.0, NAN2 and/or others to enable the STAs 103 to discover other STAs 103, devices and/or services that may be operating in a relatively close proximity. As an example, multiple STAs 103 may form a NAN data cluster (NDC) and may be synchronized to a same clock and/or a same reference timing. The STAs 103 may converge on a time period and channel included as part of a discovery window (DW) to facilitate the discovery of services of other STAs 103 and/or other devices. The discovery may be performed, in some cases, with little or no involvement from an access point (AP) or other infrastructure components, although embodiments are not limited as such. In some embodiments, one or more signals transmitted by an AP may be used by one or more STAs 103 to determine a reference timing and/or a schedule for a NAN communication. In some embodiments, one or more STAs 103 may exchange one or more control messages with an AP to at least partly enable a NAN communication. For instance, the NAN communication may be established based at least partly on a control message received from an AP, in some embodiments.

In some cases, STAs 103 and/or other devices may transmit data to each other with little or no involvement of an infrastructure. As an example, one STA 103, say STA #1, may advertise time blocks for further availability called further availability window (FAW) in a discovery window (DW), and another STA 103, say STA #2, may go to the FAW and form a NAN Data link (NDL) with STA #1 to transmit data to each other. Each NDL may have an NDL schedule with specifically agreed time blocks, which may or may not be in the same channel. Furthermore, different NDLs, STAs 103 and/or other devices may form an NDC, and a common NDC base schedule may manage operation and/or communication between the STAs 103 in the NDC, in some cases.

In accordance with some embodiments, the STAs 103 and/or master STA 102 may be arranged to contend for a wireless medium (e.g., during a contention period) to receive exclusive control of the medium for a transmission period. For instance, the transmission period may include a transmission opportunity (TXOP), which may be included in an 802.11 standard and/or other standard. In some embodiments, a length of the transmission period may be variable. For instance, a length of the transmission period may be variable according to an amount of data that is to be sent, but may be bounded by a maximum permitted length (which may or may not be part of a standard). Accordingly, when a small amount of data is to be transmitted, a relatively small transmission period may be used. When a large amount of data is to be transmitted, a relatively large transmission period may be used and in some cases, the data may be divided and sent over multiple transmission periods in accordance with a maximum permitted length of the transmission period.

The data transmissions may be performed in accordance with any suitable multiple-access techniques and/or multiplexing techniques. Accordingly, one or more of orthogonal frequency division multiple access (OFDMA), orthogonal frequency division multiplexing (OFDM), code-division multiple access (CDMA), time-division multiple access (TDMA), frequency division multiplexing (FDMA), space-division multiple access (SDMA), multiple-input multiple-output (MIMO), multi-user (MU) multiple-input multiple-output (MIMO) (MU-MIMO) and/or other techniques may be employed in some embodiments.

In some embodiments, the STA 103 may communicate with other STAs 103 and/or the master STA 102 in accordance with legacy IEEE 802.11 communication techniques. These embodiments are not limiting, however, as non-legacy IEEE 802.11 techniques or a combination of legacy and non-legacy IEEE 802.11 techniques may be used in some embodiments.

In some embodiments, channels used for communication between STAs 103 and/or master STAs 102 may be configurable to use one of 20 MHz, 40 MHz, or 80 MHz contiguous bandwidths or an 80+80 MHz (160 MHz) non-contiguous bandwidth. In some embodiments, a 320 MHz channel width may be used. In some embodiments, subchannel bandwidths less than 20 MHz may also be used. In these embodiments, each channel or subchannel may be configured for transmitting a number of spatial streams, in some embodiments. These embodiments are not limiting, however, as other suitable bandwidths may be used in some embodiments.

In some embodiments, high-efficiency wireless (HEW) techniques may be used, although the scope of embodiments is not limited in this respect. As an example, techniques included in 802.11ax standards and/or other standards may be used. In such embodiments, an HEW packet may be generated in accordance with a short preamble format or a long preamble format. The HEW packet may comprise a legacy signal field (L-SIG) followed by one or more high-efficiency (HE) signal fields (HE-SIG) and an HE long-training field (HE-LTF). For the short preamble format, the fields may be configured for shorter-delay spread channels. For the long preamble format, the fields may be configured for longer-delay spread channels. It should be noted that the terms “HEW” and “HE” may be used interchangeably and both terms may refer to high-efficiency Wireless Local Area Network operation and/or high-efficiency Wi-Fi operation.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware. Embodiments described herein may be implemented into a system using any suitably configured hardware and/or software.

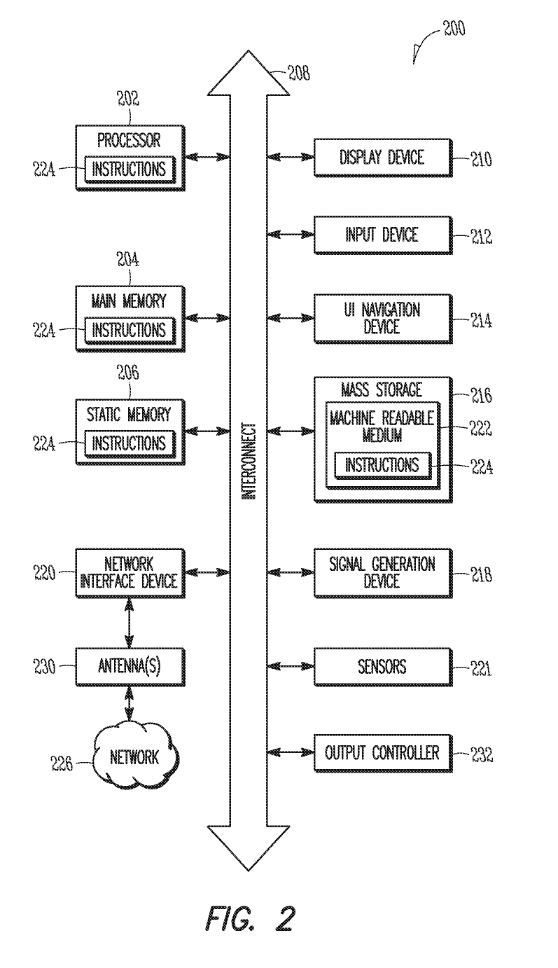

FIG. 2 illustrates a block diagram of an example machine in accordance with some embodiments. The machine 200 is an example machine upon which any one or more of the techniques and/or methodologies discussed herein may be performed. In alternative embodiments, the machine 200 may operate as a standalone device or may be connected (e.g., networked) to other machines. In a networked deployment, the machine 200 may operate in the capacity of a server machine, a client machine, or both in server-client network environments. In an example, the machine 200 may act as a peer machine in peer-to-peer (P2P) (or other distributed) network environment. The machine 200 may be a master STA 102, STA 103, access point (AP), UE, eNB, mobile device, base station, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The machine (e.g., computer system) 200 may include a hardware processor 202 (e.g., a central processing unit (CPU), a graphics processing unit (GPU), a hardware processor core, or any combination thereof), a main memory 204 and a static memory 206, some or all of which may communicate with each other via an interlink (e.g., bus) 208. The machine 200 may further include a display unit 210, an alphanumeric input device 212 (e.g., a keyboard), and a user interface (UI) navigation device 214 (e.g., a mouse). In an example, the display unit 210, input device 212 and UI navigation device 214 may be a touch screen display. The machine 200 may additionally include a storage device (e.g., drive unit) 216, a signal generation device 218 (e.g., a speaker), a network interface device 220, and one or more sensors 221, such as a global positioning system (GPS) sensor, compass, accelerometer, or other sensor. The machine 200 may include an output controller 228, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a machine readable medium 222 on which is stored one or more sets of data structures or instructions 224 (e.g., software) embodying or utilized by any one or more of the techniques or functions described herein. The instructions 224 may also reside, completely or at least partially, within the main memory 204, within static memory 206, or within the hardware processor 202 during execution thereof by the machine 200. In an example, one or any combination of the hardware processor 202, the main memory 204, the static memory 206, or the storage device 216 may constitute machine readable media. In some embodiments, the machine readable medium may be or may include a non-transitory computer-readable storage medium.

While the machine readable medium 222 is illustrated as a single medium, the term “machine readable medium” may include a single medium or multiple media (e.g., a centralized or distributed database, and/or associated caches and servers) configured to store the one or more instructions 224. The term “machine readable medium” may include any medium that is capable of storing, encoding, or carrying instructions for execution by the machine 200 and that cause the machine 200 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 224 may further be transmitted or received over a communications network 226 using a transmission medium via the network interface device 220 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 220 may include one or more physical jacks (e.g., Ethernet, coaxial, or phone jacks) or one or more antennas to connect to the communications network 226. In an example, the network interface device 220 may include a plurality of antennas to wirelessly communicate using at least one of single-input multiple-output (SIMO), multiple-input multiple-output (MIMO), or multiple-input single-output (MISO) techniques. In some examples, the network interface device 220 may wirelessly communicate using Multiple User MIMO techniques. The term “transmission medium” shall be taken to include any intangible medium that is capable of storing, encoding or carrying instructions for execution by the machine 200, and includes digital or analog communications signals or other intangible medium to facilitate communication of such software.

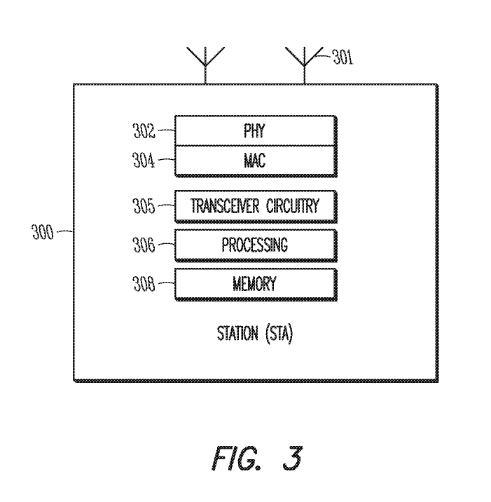

FIG. 3 illustrates a user station (STA) in accordance with some embodiments. It should be noted that in some embodiments, an STA or other mobile device may include some or all of the components shown in either FIG. 2 or FIG. 3 (as in 300) or both. The STA 300 may be suitable for use as an STA 103 as depicted in FIG. 1, in some embodiments. The STA 300 may be suitable for use as a master STA 102 as depicted in FIG. 1, in some embodiments. Accordingly, references to an STA 300 are not limiting, and may be applicable to a master STA in some cases.

The STA 300 may include physical layer circuitry 302 and a transceiver 305, one or both of which may enable transmission and reception of signals to and from components such as the master STA 102 (FIG. 1), other STAs or other devices using one or more antennas 301. As an example, the physical layer circuitry 302 may perform various encoding and decoding functions that may include formation of baseband signals for transmission and decoding of received signals. As another example, the transceiver 305 may perform various transmission and reception functions such as conversion of signals between a baseband range and a Radio Frequency (RF) range. Accordingly, the physical layer circuitry 302 and the transceiver 305 may be separate components or may be part of a combined component. In addition, some of the described functionality related to transmission and reception of signals may be performed by a combination that may include one, any or all of the physical layer circuitry 302, the transceiver 305, and other components or layers. The STA 300 may also include medium access control layer (MAC) circuitry 304 for controlling access to the wireless medium. The STA 300 may also include processing circuitry 306 and memory 308 arranged to perform the operations described herein.

The antennas 301, 230 may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas 301, 230 may be effectively separated to take advantage of spatial diversity and the different channel characteristics that may result.

In some embodiments, the STA 300 may be a mobile device and may be a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a wearable device such as a medical device (e.g., a heart rate monitor, a blood pressure monitor, etc.), or other device that may receive and/or transmit information wirelessly. In some embodiments, the STA 300 may be configured to operate in accordance with 802.11 standards, although the scope of the embodiments is not limited in this respect. Mobile devices or other devices in some embodiments may be configured to operate according to other protocols or standards, including other IEEE standards, Third Generation Partnership Project (3GPP) standards or other standards. In some embodiments, the STA 300 or other device may include one or more of a keyboard, a display, a non-volatile memory port, multiple antennas, a graphics processor, an application processor, speakers, and other mobile device elements. The display may be an LCD screen including a touch screen.

Although the STA 300 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. Some embodiments may include one or more processors and may be configured with instructions stored on a computer-readable storage device.

It should be noted that in some embodiments, an apparatus used by the STA 300 may include various components of the STA 300 as shown in FIG. 3 and/or the example machine 200 as shown in FIG. 2. Accordingly, techniques and operations described herein that refer to the STA 300 (or 103) may be applicable to an apparatus for an STA.

In some embodiments, the STA 300 may communicate using OFDM communication signals over a multicarrier communication channel. Accordingly, in some cases the STA 300 may be configured to receive signals in accordance with specific communication standards, such as the Institute of Electrical and Electronics Engineers (IEEE) standards including IEEE 802.11-2012, 802.11n-2009 and/or 802.11ac-2013 standards and/or proposed specifications for WLANs including proposed HEW standards, although the scope of the embodiments is not limited in this respect as they may also be suitable to transmit and/or receive communications in accordance with other techniques and standards. In some other embodiments, the STA 300 may be configured to receive signals that were transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, channel resources may be used for transmissions of signals between STAs 103. Although embodiments are not limited as such, the transmissions may be performed in accordance with contention based techniques and/or time-division duplex (TDD) techniques in some cases. In some embodiments, the channel resources may include multiple channels, such as the 20 MHz channels previously described. The channels may include multiple sub-channels or may be divided into multiple sub-channels to accommodate multiple access for multiple STAs 103, in some cases. In some embodiments, the sub-channels may comprise a predetermined bandwidth. As a non-limiting example, the sub-channels may each span 2.03125 MHz, the channel may span 20 MHz, and the channel may include eight or nine sub-channels. However, any suitable frequency span for the channels and/or sub-channels may be used. In some embodiments, the frequency span for the sub-channel may be based on a value included in an 802.11 standard (such as 802.11ax), a 3GPP standard or other standard. In some embodiments, the sub-channels may comprise multiple sub-carriers. Although not limited as such, the sub-carriers may be used for transmission and/or reception of OFDM or OFDMA signals. As an example, each sub-channel may include a group of contiguous sub-carriers spaced apart by a pre-determined sub-carrier spacing. As another example, each sub-channel may include a group of non-contiguous sub-carriers. That is, the channel may be divided into a set of contiguous sub-carriers spaced apart by the pre-determined sub-carrier spacing, and each sub-channel may include a distributed or interleaved subset of those sub-carriers. The sub-carrier spacing may take a value such as 78.125 kHz, 312.5 kHz or 15 kHz, although these example values are not limiting. Other suitable values that may or may not be part of an 802.11 or 3GPP standard or other standard may also be used in some cases. As an example, for a 78.125 kHz sub-carrier spacing, a sub-channel may comprise 26 contiguous sub-carriers or a bandwidth of 2.03125 MHz.

In accordance with some embodiments, as part of a Neighborhood Awareness Network (NAN) communication, an originating STA 103 may perform a group of one or more data transmissions to a destination STA 103 during a current time block. The data transmissions may be performed in accordance with a NAN Data Link (NDL) established between the originating STA 103 and the destination STA 103. An initial data transmission of the group may be delayed, with respect to a determined idle period of the current time block, by a back-off count selected in accordance with a starting contention window (CW) size. In some embodiments, the starting CW size may be based at least partly on a previous CW size used by the originating STA 103 for a data transmission during a previous time block. These embodiments will be described in more detail below.

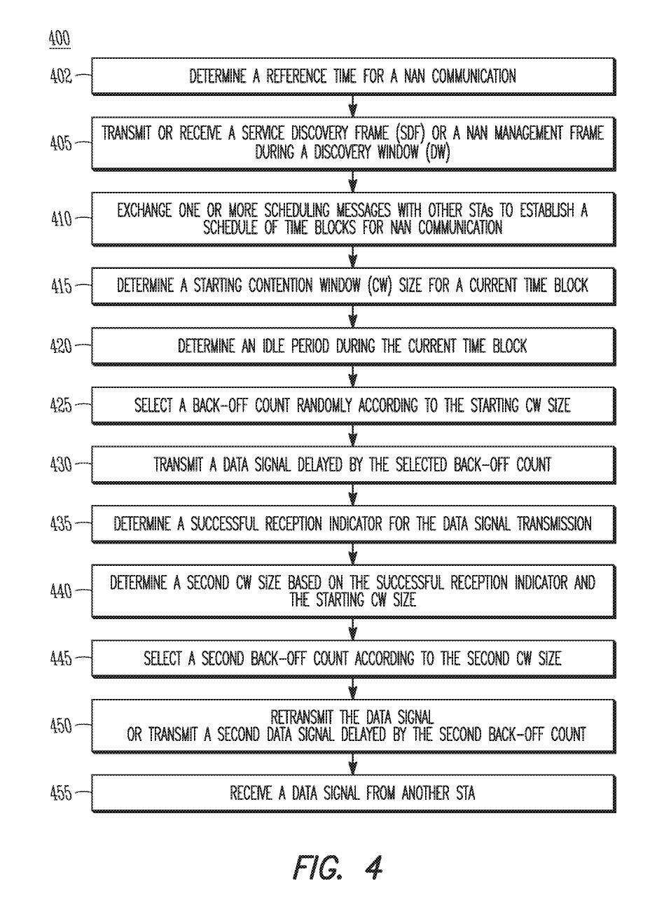

FIG. 4 illustrates the operation of a method of determination of channel resources in accordance with some embodiments. It is important to note that embodiments of the method 400 may include additional or even fewer operations or processes in comparison to what is illustrated in FIG. 4. In addition, embodiments of the method 400 are not necessarily limited to the chronological order that is shown in FIG. 4. In describing the method 400, reference may be made to FIGS. 1-3 and 5, although it is understood that the method 400 may be practiced with any other suitable systems, interfaces and components.

In addition, while the method 400 and other methods described herein may refer to STAs 103 and/or master STAs 102 operating in accordance with 802.11 or other standards, embodiments of those methods are not limited to just those devices and may also be practiced on other mobile devices, such as an HEW STA, an Evolved Node-B (eNB) or User Equipment (UE). The method 400 and other methods described herein may also be practiced by wireless devices configured to operate in other suitable types of wireless communication systems, including systems configured to operate according to various Third Generation Partnership Project (3GPP) Long Term Evolution (LTE) standards. The method 400 may also be applicable to an apparatus for an STA 103 and/or master STA 102 or other device described above, in some embodiments.

It should also be pointed out that reference may be made herein to an “originating STA 103” and/or “destination STA 103.” For instance, an operation may include transmission of a signal from an originating STA 103 to a destination STA 103. These references are not limiting, however. In some embodiments, an STA 103 may be configured to perform operations described herein for either an originating STA 103, a destination STA 103 or both.

In some embodiments, an NDL between an originating STA 103 and a destination STA 103 may be used during one or more time blocks of a schedule. Accordingly, such time blocks may be referred to as “NDL time blocks” in some cases. In some embodiments, NAN communication by STAs 103 in an NDC may be used during one or more time blocks of a schedule. Accordingly, such time blocks may be referred to as “NDC time blocks” in some cases. In addition, reference may be made herein to an NDL time block, NAN time block, NDC time block and/or other time block, but such references are not limiting. For instance, operations and/or techniques described herein for a type of time block may be applicable to other types of time blocks, in some embodiments.

In some embodiments, a NAN communication and/or communication between STAs 103 and/or a master STA 102 may be performed in one or more channels. The channels may or may not be adjacent in frequency, and may span any suitable bandwidth including but not limited to the values described previously. As a non-limiting example, a group of 20 MHz channels may be used.

In some embodiments, a NAN communication may be based on time blocks. In some cases, one or more STAs 103 and/or devices may be synchronized for such a communication. For instance, a starting time of one or more time blocks in a pattern or sequence may be based on a reference timing determined by each of the STAs 103. In some cases, it is possible that multiple devices may start access in the same time block and may transmit packets. Hence, some contention mitigation scheme may be used for different types of time blocks, including but not limited to, FAW, NDC, and NDL time blocks. An FAW time block may be announced by a particular STA 103 to enable other STAs 103 to contact the particular STA 103 to establish a data link. An NDC base schedule may include one or more NDC time blocks agreed to by all devices in the same NDC. An NDL schedule may include one or more NDL time blocks to which two STAs 103 have agreed for NAN data transmission. In some cases, a same time block may be used by multiple devices for NAN communication.

At operation 402 of the method 400, the originating STA 103 may determine a reference timing to be used for Neighborhood Awareness Network (NAN) communication with one or more other STAs 103. In some embodiments, the NAN communication may include a NAN Data Link (NDL) communication. In some embodiments, the NAN communication may include a NAN Data Cluster (NDC) communication, in which STAs 103 in an NDC may communicate with each other. Accordingly, the reference timing may be used by the STAs 103 to synchronize NAN communication. For instance, a starting time (or other time) of a particular time block, such as a discovery window (DW), further availability window (FAW), NDL time block, NDC time block and/or other time block may be based on the reference timing.

In some embodiments, the reference timing may be determined based on a reception of one or more synchronization signals and/or other signals from a master STA 102. Accordingly, multiple STAs 103 may receive those signals and/or other signals from the master STA 102, and the STAs 103 may synchronize for the NAN communication. These embodiments are not limiting, however, as other techniques may be used. For instance, a particular STA 103 may transmit one or more synchronization signals, beacon signals and/or other signals, and other STAs 103 may synchronize to a reference timing that the particular STA 103 wishes to establish. In some embodiments, the STAs 103 may synchronize to a common timing and/or schedule by exchanging signals with each other. In some cases, the signals may be exchanged at least partly to enable synchronization, although embodiments are not limited as such. In some embodiments, the signals may not necessarily have been transmitted for purposes of enabling the synchronization.

It should also be pointed out that in some embodiments, the STAs 103 may exchange one or more control signals with the master STA 102 as part of the establishment of the NAN communication. For instance, control information for the NAN communication may be received from the master STA 102, such as which channels are available and/or unavailable for the NAN communication. Embodiments are not limited as such, however, as STAs 103 may exchange and/or broadcast such control signals in some embodiments. For instance, in some cases, a master STA 102 may not be used.

At operation 405, the originating STA 103 may exchange one or more signals with one or more destination STAs 103 during a discovery window (DW). As an example, the originating STA 103 may transmit a service discovery frame (SDF) or a NAN management frame during the DW. The SDF may announce a capability of the originating STA 103 (such as a capability for NAN operation by the originating STA 103 or other capability), an availability of the originating STA 103 to provide a service (which may or may not be related to NAN operation) and/or other related information. The NAN management frame may be related to a NAN data link (NDL) communication, a NAN data cluster (NDC) communication and/or other NAN communication, in some cases. As another example, the originating STA 103 may receive an SDF and/or NAN management frame during the DW. In some embodiments, the DW may include a time block allocated on a particular channel to enable STAs 103 to discover services of each other. For instance, the discovery may be performed by the STAs 103 using direct communication between STAs 103, in which access points (APs) and/or other infrastructure components may have no involvement or limited involvement, in some cases.

At operation 410, the originating STA 103 may exchange one or more scheduling messages with one or more other STAs. In some embodiments, the scheduling messages may be exchanged during a further availability window (FAW), which may include a time block allocated on a particular channel subsequent to the DW, to enable STAs 103 to negotiate a schedule for NAN communication. Accordingly, the originating STA 103 may transmit and/or receive one or more scheduling messages from one or more other STAs 103. In some embodiments, the scheduling messages may be transmitted in accordance with a contention based access during the FAW. As will be described below, other transmissions during other time blocks may be performed in accordance with other contention based access operations that may or may not be related to contention based access operations performed during the FAW. For instance, contention windows (CWs), back-off counts and/or other parameters used during the FAW may not necessarily be related to similar parameters used in other time blocks, in some cases.

At operation 415, a starting CW size may be determined for a current time block. Examples of such will be presented below. It should be noted that in some embodiments, the time blocks used in the method 400 may be any suitable type of time block, including but not limited to an NDL time block (which may be a time block for which the originating STA 103 and the destination STA 103 may communicate over an NDL between them). As an example, during a current time block, the originating STA 103 may contend for access to a channel/wireless medium in order to communicate with the destination STA 103 other over the NDL established between the originating STA 103 and the destination STA 103. It should be noted that the time block may be used for other NDLs in some cases, such as NDLs established between other pairs of STAs 103.

Embodiments are not limited to NDL time blocks, however. In some embodiments, operations such as 415-450 and/or others may be applicable to an NDC time block. In addition, other time blocks may be used in some embodiments.

At operation 420, the originating STA 103 may determine an idle period during the current time block. The originating STA 103 may select a back-off count randomly according to the starting CW size at operation 425. At operation 430, a data signal may be transmitted by the originating STA 103 in accordance with the selected back-off count. For instance, the transmission may be delayed by the selected back-off count with respect to an ending time of the idle period determined at operation 420. Embodiments are not limited to usage of the back-off count as the delay, however, as other delays related to the back-off count may be used. As non-limiting examples of such, the transmission may be delayed by at least the back-off count or may be delayed by a value that is approximately equal to the back-off count. It should also be noted that in some embodiments, the back-off count may be determined based at least partly on a previous back-off count. For instance, a back-off count (or at least a portion of it) may be carried over from a previous time block for usage as the back-off count for a first chronological transmission in the current time block.

It should be noted that the operations 415-430 may be applicable to other data transmissions using a CW size other than the starting CW size. As an example, the originating STA 103 may perform a group of one or more data transmissions to one or more destination STAs 103 during the current time block. As an example, the group of STAs 103 may be the STAs 103 that establish NDL with the original STAs 103 and include the current time block. The starting CW size may be used for a first chronological (earliest) data transmission in the group, and the starting CW size may be chosen based on the number of STAs in the group.

The data transmissions may be performed over direct wireless link(s) between the originating STA 103 and the destination STA(s) 103 and in accordance with an NAN protocol, in some embodiments. Accordingly, contention based access may be used for the data transmissions. In some embodiments, the usage of an idle period detection, a CW, a back-off count, transmission delay and/or other concepts for contention based access may be performed in accordance with a carrier sense multiple access with collision avoidance (CSMA/CA) protocol. As an example, the CSMA/CA protocol may be included in an 802.11 standard and/or other standard, in some cases, although embodiments are not limited to usage of CSMA/CA techniques that are included in a standard.

In some embodiments, a particular data transmission may be delayed, with respect to an ending time of a detected idle period of the channel and/or other time, by a back-off count. The back-off count may be drawn (for instance, determined randomly or pseudo-randomly) from an interval that spans a range of values up to the CW size. As an example, the CW size may be given in terms of a number of time slots, time intervals, time units (microseconds, milliseconds, seconds and/or other unit) in some cases. For instance, the range of values from which the back-off count is selected may span from a single time unit up to CW time units. Any suitable selection method may be used, including but not limited to uniform selection within the range of values.

In some embodiments, CW sizes described herein may be selected from a group of values. Any suitable group of values may be used. As a non-limiting example, the group of values may include one or more integers of the form 2̂n−1, in which “n” may be restricted to integers greater than 1. In some cases, the group of values may be restricted to integers of that form and may be further restricted to a particular set of values for “n”. For instance, the group of values may include and/or may be restricted to 3, 7, 15, 31, 63, 127, and 255 (in which case “n” takes values in the range of 2-8). This group of values may be included as part of an 802.11 standard and/or other standard, in some cases, although embodiments are not limited as such. This example is not limiting in terms of the size of the group, the formula to determine the values in the group and/or other aspects. In some embodiments, the values in the group may not necessarily be describable and/or determinable by a formula (such as 2̂n−1 or other formula).

In some embodiments, the originating STA 103 may perform operations such as channel sensing, bandwidth sensing, spectrum analysis, signal energy detection, decoding of packets or others to determine the idle period of the channel. Accordingly, the STA 103 may determine whether a channel is idle based on monitoring of activity of other STAs 103, APs and/or other devices, in some cases. As an example, when transmission activity is detected, the channel (wireless medium) may be determined to be busy or unavailable for the intended data transmission by the originating STA 103.

In some embodiments, the originating STA 103 may monitor the channel for a particular time period to determine whether the channel is idle. As a non-limiting example, various inter-frame spacing (IFS) included in 802.11 standards may be used, such as an xIFS, short IFS (SIFS) and/or other. Embodiments are not limited to the usage of an IFS, however, as any suitable interval, which may or may not be included in a standard, may be used in some embodiments.

In some embodiments, a group of one or more NDC time blocks may be allocated for a NAN communication between STAs 103 included in an NDC. The starting CW size for an NDC time block may be based at least partly on a number of STAs 103 included in the NDC. For instance, when the number of STAs 103 in the NDC is relatively low, a low value of the starting CW size for the NDC time block may be used. For a higher number of STAs 103 in the NDC, a higher value of the starting CW size of the NDC time block may be used.

In some embodiments, the starting CW size may be determined for an NDL between the originating STA 103 and a destination STA 103 during a current time block. As a non-limiting example, the starting CW size for the NDL during the current time block may be determined at least partly based on a determined number of other STAs 103 that transmitted a data signal during one or more previous time blocks. In some cases, the starting CW size for the NDL during the current time block may be determined at least partly based on a determined number of data transmissions during one or more previous time blocks. For instance, the other STAs 103 (such as pairs of STAs 103, in some cases) may have NDLs established between them, and the data transmissions on those NDLs during the one or more previous time blocks may be used as part of the determination of the CW size during the current time block. As another non-limiting example, the starting CW size for the NDL during the current time block may be determined based at least partly on a number of STAs 103 that have established an NDL with the originating STA 103.

It should be noted that in some embodiments, the starting CW size of a time block may be based on factors such as a previously used CW size, a number of STAs 103 in an NDC and/or other factors. In some embodiments, the starting CW size may be based on a traffic type of the data signals to be transmitted and/or traffic types of data packets on which the data signals are based. As a non-limiting example, traffic type of the data packets may be one of a group of Enhanced Distributed Channel Access Function (EDCAF) traffic types that includes background, best effort, video and voice. These example EDCAF traffic types are not limiting, however, as other types may be used in some cases, including but not limited to data, management, control and/or other suitable types.

In some embodiments, the usage of the traffic types may be used in addition to or in place of other factors for a determination of a starting CW size. For instance, various combinations of traffic type, a number of STAs 103 in an NDC cluster, previously used CW sizes (such as a final CW size or other) and/or other factors may be used to determine the starting CW size.

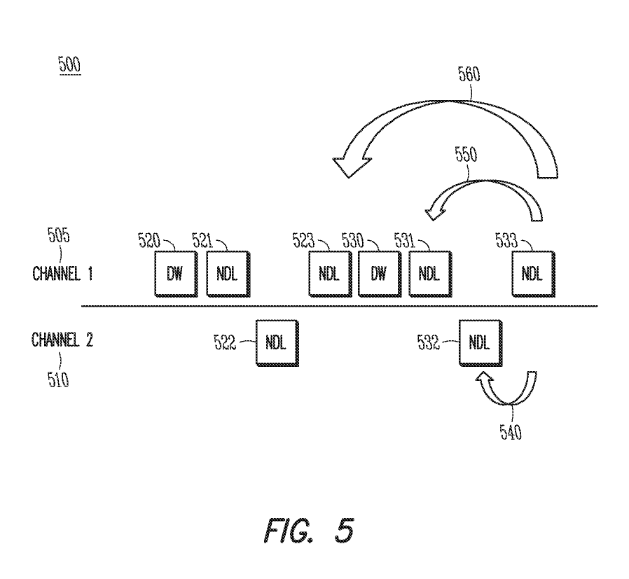

FIG. 5 illustrates an example of a schedule of time blocks in accordance with some embodiments. It should be noted that the scenario 500 shown in FIG. 5 may serve to illustrate some or all of the concepts and techniques described herein, but embodiments are not limited to those example scenarios. For instance, embodiments are not limited to the number, type, ordering or arrangement of time blocks as shown in FIG. 5. Embodiments are also not limited to the number of channels shown or to the number, type, ordering or arrangement of the time blocks in each channel as shown in FIG. 5. It should also be noted that NDL time blocks are shown in the example of FIG. 5, but embodiments are not limited as such. Other time blocks, such as NDC time blocks, may be used in some embodiments.

In the example scenario 500, a sequence of time blocks may be used for management of a NAN communication and for data transmissions as part of the NAN communication. The DW 520 on channel 1 may be followed by NDL 521 on channel 1, NDL 522 on channel 2, and NDL 523 on channel 1. As shown in FIG. 5, this pattern is repeated with blocks 530-533, although embodiments are not limited to the usage of a pattern or limited to the size of the pattern shown. In some embodiments, a DW may occur prior to a FAW, and the FAW may occur prior to a sequence of NDL time blocks.

In some embodiments, a starting CW size used for a particular NDL time block may be based at least partly on a previous CW size used in a previous NDL time block. As an example, the starting CW size of a current NDL time block may be determined based at least partly on a final CW size used by the originating STA for contention based access during a previous NDL time block. The originating STA 103 may have performed a group of data transmission during the previous NDL time block, and the final CW size may be the CW size used for a last chronological (latest) data transmission of that group, in some cases.

In some embodiments, the final CW size used in the previous NDL time block may be carried over to the current NDL time block for usage as the starting CW size. Several non-limiting examples are shown in FIG. 5, in which a starting CW size is determined for the NDL time block 533.

In the example indicated by 540, the previous NDL time block from which the final CW size is carried over may be NDL time block 532, which is the NDL time block immediately before the NDL time block 533 in this example (even though NDL time blocks 532 and 533 are on different channels).

In the example indicated by 550, the previous NDL time block from which the final CW size is carried over may be the NDL time block 531, which is the latest NDL time block before NDL time block 533 that is on the same channel as NDL time block 533. That is, the previous NDL time block from which the final CW size is carried over may be restricted to NDL time blocks on the same channel as NDL time block 533, in this example.

In the example indicated by 560, the previous NDL time block from which the final CW size is carried over may be the NDL time block 523, which is determined according to a repetition pattern. That is, the pattern of times and channels of blocks 520-523 are repeated for blocks 530-533, and the NDL time block 523 occupies the same time/channel within the repetition pattern as NDL time block 533. The examples 540-560 are not limiting, and any suitable method for carrying over a previous CW size for usage in the current NDL time block may be used.

Returning to the method 400, at operation 435, a successful reception indicator for the first (chronological) data signal transmission may be determined. In some embodiments, the originating STA 103 may receive, or attempt to receive, an acknowledgement message for the first data signal transmission from the destination STA 103. As an example, the reception of the acknowledgement message at the originating STA 103 may be unsuccessful. Accordingly, it may be determined that the first data signal transmission was unsuccessful (or at least it may be determined that a retransmission of the data signal is to be performed). As another example, the acknowledgement message may be received at the originating STA 103 and may indicate that the destination STA 103 failed to decode one or more data packets transmitted as part of the first data signal transmission. Accordingly, the first data signal transmission may be determined to be (at least partly) unsuccessful and it may be determined that a retransmission is necessary. As another example, the acknowledgement message may be received at the originating STA 103 and may indicate that the data packets transmitted as part of the first data signal transmission were decoded successfully at the destination STA 103. Accordingly, the first data signal transmission may be determined to be successful.

At operation 440, a second CW size for a second chronological data signal transmission and/or next data signal transmission by the originating STA 103 during the current NDL time block may be determined. At operation 445, a second back-off count may be selected in accordance with the second CW size (using previously described techniques or other techniques). At operation 450, the second data signal transmission may be performed. It should be noted that the second data signal transmission may be either a retransmission of the first data signal transmission or a transmission of a second data signal or a combination thereof.

In some embodiments, the second CW size may be based on the starting CW size and may be further based on the successful reception indicator for the first data signal transmission (which was performed in accordance with the starting CW size). As an example, if the successful reception indicator indicates that the transmission of the first data signal was unsuccessful, the second CW size may be determined by increasing the starting CW size. For instance, the starting CW size may be doubled (or approximately doubled) to produce the second CW size in this case. As another example, if the successful reception indicator indicates that the transmission of the first data signal was successful, the second CW size may be determined by decreasing the starting CW size. For instance, a value equal to or approximately equal to half of the starting CW size may be used as the second CW size in this case.

In some embodiments, the second CW size may be based on the successful reception indicator for the first data signal transmission and may not necessarily depend on the starting CW size. As an example, if the successful reception indicator indicates that the transmission of the first data signal was successful, the second CW size may be set to a particular value which may or may not depend on the starting CW size. For instance, the starting CW size may take a value of 127 in a first scenario and may take a value of 15 in a second scenario. In either scenario, if the successful reception indicator indicates that the transmission of the first data signal was successful, the second CW size may be set to a value of 7 independent of the starting CW size. It should be noted that embodiments are not limited to the numbers used in this example.

At operation 455, the originating STA 103 may receive one or more data signals from one or more other STAs 103 as part of the NAN communication. As previously described, although reference is made to the originating STA 103, an STA 103 may be configured to operate as either an originating STA 103 (such as when sending data to one or more other STAs 103) and/or a destination STA 103 (such as when receiving data from one or more other STAs 103).

It should be noted that in some embodiments, an originating STA 103 may be included in an NDC. As an example, the originating STA 103 may also perform NAN communication with other STAs 103 outside of the NDC and/or STAs 103 in another NDC. Accordingly, two or more NAN communications may be supported by the originating STA 103. As another example, the originating STA 103 may communicate (at least temporarily) with other STAs 103 in the NDC and may not necessarily perform any NAN communication with other STAs 103 outside of the NDC. In these and other examples, one or more operations of the method 500 may be used for data transmission in an NDL time block, an NDC time block and/or other time block. As an example, the originating STA 103 may perform a first NAN communication with another STA 103 and may perform a second NAN communication with an NDC that includes the originating STA 103. One or more operations (such as determination of a starting CW size and/or others) may be performed for each of the first and second NAN communications. In some cases, the operations may be performed independently for each of the first and second NAN communications, although embodiments are not limited as such.

In some embodiments, for an NDC time block, a starting CW size may be determined based at least partly on a number of STAs 103 included in an NDC (that includes the originating STA 103). The originating STA 103 may transmit, to a destination STA 103 included in the NDC, a data signal delayed by a back-off count with respect to an idle period of the NDC time block. The back-off count may be selected randomly in accordance with the starting CW size of the NDC time block, in some cases. The data signal may be transmitted as part of a first chronological data transmission of a group of one or more data transmissions by the originating STA 103 during the NDC time block. In some cases, the NDC time block may be included in a sequence of NDC time blocks allocated at least partly for an NAN communication between the STAs 103 in the NDC. In addition, the starting CW may be further based at least partly on a traffic type of the data packets, such as the EDCAF traffic types described herein and/or other traffic types. The originating STA 103 may perform other operations as part of the NAN communication with other STAs 103 in the NDC, including determination of a successful reception indicator, determination of a second CW size for a retransmission and/or second data transmission, determination of a second idle period in the NDC block, determination of a second back-off count based on the second CW size, and performance of the retransmission and/or second data transmission in accordance with a delay related to the second back-off count.

In some embodiments, one or more contention mitigation methods may be used as part of a NAN communication. Several non-limiting examples will be presented below. It should be noted that some embodiments may use one or more of the contention mitigation methods described below. Some embodiments may use one or more operations from one or more of the contention mitigation methods described below. In addition, some embodiments may use additional operations (including but not limited to those described herein) in addition to one or more operations from one or more of the contention mitigation methods described below.

In an example contention mitigation method, a back-off may be triggered during a time block even if the medium is idle for a first (initial) channel sensing interval used by the STA 103 during the time block. The interval may be an xIFS time interval included in an 802.11 standard, although other suitable time intervals may be used. That is, the STA 103 may refrain from skipping the back-off during the first channel sensing interval of the time block. In some cases, the back-off may occur after the start of the time block and the channel sensing may begin after the start of the time block.

In another example contention mitigation method, one or more parameters may be carried over to a current time block from one or more previous time blocks. As an example, a back-off counter may be carried over from a previous time block. As another example, a contention window (CW) size may be carried over from a previous time block and a back-off counter (or interval) may be drawn according to the CW size. As another example, the back-off counter and/or CW size may be carried over from a previous time block that is of the same type as the current time block. As another example, the back-off counter and/or CW size may be carried over from the immediately previous time block. As another example, the back-off counter and/or CW size may be carried over from the previous time block that is in the same channel as the current time block. As another example, the back-off counter and/or CW size may be carried over from the previous time block that is in a same position of a periodic time block pattern (and/or DW block pattern). As another example, the back-off counter and/or CW size may be reset when the channel of the previous time block is different from the channel of the current time block. That is, if a carrying over operation is not used, then the STA 103 may always reset the CW and may re-draw the back-off counter, in some cases. Accordingly, the starting CW size may not necessarily depend on a CW size used in previous time blocks, in some cases.

In another example contention mitigation method, the CW size may be determined dynamically by each STA. For instance, for an NDC time block of an NDC base schedule, the STA 103 may determine and/or calculate a number of neighboring stations in the same NDC. The number may be based on a number of established NDLs, in some cases, although embodiments are not limited as such. The STA 103 may select a value for the CW size that is larger than the number of neighboring stations determined. As an example, the value for the CW size may be included in a standard. As another example, the value for the CW size may be selected such that the CW size is larger than a value included in the standard.

In another example contention mitigation method, EDCAF techniques may be used for the transmission of a NAN management frame, an SDF frame, a paging frame, a trigger frame, or a data frame. For instance, any suitable number of access categories (such as four or other) may be defined. Devices may use a specific category to transmit a NAN management frame, an SDF frame, a paging frame, a trigger frame, or a data frame. For example, the NAN management and the SDF frame may be treated as AC_VO and the paging frame may be treated as AC_VI. An initial CW (starting CW size) may be determined. As an example, for NDC time blocks of an NDC base schedule, devices may estimate the known stations in the same NDC. As another example, for NDL time blocks of an NDL schedule, devices may estimate the known stations with agreed NAN time blocks overlapping the starting time of the current time block. As another example, when a transmission succeeds, an EDCAF mechanism may be followed. For instance, a minimum CW size (such as CWmin) may be used for a specific access category when the transmission for a specific access category is successful. When the transmission fails, a next larger feasible window may be used as part of an exponential back-off. As another example, an initial CW may be chosen based on a defined/suggested value included in a standard. For instance, the chosen CW may be selected as a value larger than a defined value in a standard. As another example, the initial CW may be chosen from one of a set of feasible values of EDCAF. For instance, as part of an exponential back-off, valid EDCAF CW values may be 3, 7, 15, 31, 63, 127, and 255. As another example, the initial CW may be chosen from a set of feasible values and in accordance with a determined number of STAs 103 and/or devices. For instance, if there are X devices determined, the smallest feasible Y such that Y>X may be used as the CW size.

In another example contention mitigation method, a first CW size may be used in the DW and a second CW size may be used in NDL time blocks and NDC time blocks. For instance, a value of 16 may be used for the CW size in the NDL/NDC time blocks and a value of 512 may be used for the CW size in the DW. In some cases, fewer devices may contend for data transmission in the NDL/NDC time blocks in comparison to a number of devices contending for discovery related transmissions in the DW.

In Example 1, an apparatus for a station (STA) may comprise transceiver circuitry and hardware processing circuitry. The STA may be configurable to operate as an originating STA. The transceiver circuitry and hardware processing circuitry may be configured to determine a starting contention window (CW) size to be used by the originating STA for contention based access for a Neighborhood Awareness Network Data Link (NDL) with a destination STA during a current time block. The transceiver circuitry and hardware processing circuitry may be further configured to detect an idle period of the current time block. The transceiver circuitry and hardware processing circuitry may be further configured to select a back-off count according to the starting CW size. The transceiver circuitry and hardware processing circuitry may be further configured to transmit a data signal to the destination STA during the current time block, the transmission of the data signal delayed by at least the back-off count with respect to an ending time of the idle period. The starting CW size may be determined based at least partly on a final CW size used by the originating STA for contention based access for the NDL during a previous time block.

In Example 2, the subject matter of Example 1, wherein the detection of the idle period and the transmission of the data signal may be performed in accordance with a carrier sense multiple access with collision avoidance (CSMA/CA) protocol.

In Example 3, the subject matter of one or any combination of Examples 1-2, wherein the starting CW size and the final CW size may be restricted to a group that includes integer values of a form in which an exponentiation of a base value of two by an integer exponent is decremented by an integer value of one. The integer exponent may be greater than an integer value of one.

In Example 4, the subject matter of one or any combination of Examples 1-3, wherein the data signal may be transmitted to the destination STA over a direct wireless link between the originating STA and the destination STA and in accordance with a Neighborhood Area Network (NAN) protocol.

In Example 5, the subject matter of one or any combination of Examples 1-4, wherein the determination of the starting CW size may include carrying over the final CW size from the previous time block for usage as the starting CW size.

In Example 6, the subject matter of one or any combination of Examples 1-5, wherein the data signal may be transmitted as part of a first chronological data signal transmission of a group of one or more data signal transmissions performed by the originating STA during the current time block. The starting CW size may be determined for usage as part of the first chronological data signal transmission of the group.

In Example 7, the subject matter of one or any combination of Examples 1-6, wherein the group of data signal transmissions is a first group of data signal transmissions and the final CW size for the previous time block may be used, by the originating STA, as part of a last chronological data signal transmission of a second group of one or more data signal transmissions performed by the originating STA during the previous time block.

In Example 8, the subject matter of one or any combination of Examples 1-7, wherein the current time block and the previous time block may be included in a sequence of time blocks allocated at least partly for a Neighborhood Area Network (NAN) communication between the originating STA and one or more other STAs.

In Example 9, the subject matter of one or any combination of Examples 1-8, wherein the transceiver circuitry and the hardware processing circuitry may be further configured to determine, based at least partly on a synchronization signal received from another STA, a reference timing for the NAN communication. The time blocks in the sequence may be based at least partly on the reference timing.

In Example 10, the subject matter of one or any combination of Examples 1-9, wherein the previous time block used in the determination of the starting CW size may be restricted to a time block in the sequence for which a channel used by the originating STA is the same as a channel used by the originating STA during the current time block.

In Example 11, the subject matter of one or any combination of Examples 1-10, wherein the transceiver circuitry and the hardware processing circuitry may be further configured to transmit, during a discovery window (DW) prior to the sequence of time blocks, a NAN management frame or a service discovery frame (SDF) that indicates a further availability window (FAW). The transceiver circuitry and the hardware processing circuitry may be further configured to transmit, during the FAW, a scheduling message for the NAN communication. The scheduling message may be transmitted in accordance with an FAW CW size that is independent of the starting CW size for the current NDL time block and the final CW size for the previous time block.

In Example 12, the subject matter of one or any combination of Examples 1-11, wherein the starting CW size may be further determined at least partly based on a determined number of data transmissions by other STAs during the previous time block or on a determined number of STAs that have established an NDL with the originating STA.

In Example 13, the subject matter of one or any combination of Examples 1-12, wherein the data signal may be based on one or more data packets, the starting CW size may be further based at least partly on a traffic type of the data packets, and the traffic type of the data packets may be one of a group of Enhanced Distributed Channel Access Function (EDCAF) traffic types that includes background, best effort, video and voice.

In Example 14, the subject matter of one or any combination of Examples 1-13, wherein the idle period is a first idle period, the data signal is a first data signal, and the back-off count is a first back-off count. The transceiver circuitry and the hardware processing circuitry may be further configured to determine a successful reception indicator for the first data signal based on an attempted reception of an acknowledgement message from the destination STA for the first data signal. The transceiver circuitry and the hardware processing circuitry may be further configured to determine a second CW size based on the successful reception indicator and further based on the starting CW size. The transceiver circuitry and the hardware processing circuitry may be further configured to detect a second idle period during the current time block. The second idle period may occur after the end of the transmission of the first data signal. The transceiver circuitry and the hardware processing circuitry may be further configured to randomly select a second back-off count according to the second CW size. The transceiver circuitry and the hardware processing circuitry may be further configured to transmit a second data signal during the current time block. The transmission of the second data signal may be delayed by at least the second back-off count with respect to an ending time of the second idle period.

In Example 15, the subject matter of one or any combination of Examples 1-14, wherein the hardware processing circuitry may include baseband circuitry to determine the starting CW size.

In Example 16, a non-transitory computer-readable storage medium may store instructions for execution by one or more processors to perform operations for channel based contention by a station (STA) configurable to operate as an originating STA. The operations may configure the one or more processors to determine, for a current time block, a starting contention window (CW) size based at least partly on a number of STAs included in a Neighborhood Area Network Data Cluster (NDC) that includes the originating STA. The operations may further configure the one or more processors to configure the originating STA to transmit, to a destination STA included in the NDC, a data signal delayed by a back-off count with respect to an idle period of the current time block. The back-off count may be selected randomly in accordance with the starting CW size. The data signal may be transmitted as part of a first chronological data transmission of a group of one or more data transmissions by the originating STA during the current time block.

In Example 17, the subject matter of Example 16, wherein the data signal may be transmitted as part of a first chronological data signal transmission of a group of one or more data signal transmissions performed by the originating STA during the current time block. The starting CW size may be determined for usage as part of the first chronological data signal transmission of the group.

In Example 18, the subject matter of one or any combination of Examples 16-17, wherein the current time block may be included in a sequence of time blocks allocated at least partly for a Neighborhood Awareness Network (NAN) communication between the STAs in the NDC. The time blocks in the sequence may be synchronized in accordance with a reference timing for the NAN communication.

In Example 19, the subject matter of one or any combination of Examples 16-18, wherein the operations may further configure the one or more processors to determine the reference timing based at least partly on a signal received from another STA.

In Example 20, the subject matter of one or any combination of Examples 16-19, wherein the operations may further configure the one or more processors to configure the originating STA to transmit, during a discovery window (DW) prior to the sequence of time blocks, a NAN management frame or a service discovery frame (SDF) that indicates a capability of the originating STA for NDL operation. The operations may further configure the one or more processors to configure the originating STA to transmit, during a further availability window (FAW) subsequent to the DW and prior to the sequence of time blocks, a scheduling message for the NAN communication. The scheduling message may be transmitted in accordance with an FAW CW size that is independent of the starting CW size for the time block.

In Example 21, the subject matter of one or any combination of Examples 16-20, wherein the data signal may be based on one or more data packets, the starting CW size may be further based at least partly on a traffic type of the data packets, and the traffic type of the data packets may be one of a group of Enhanced Distributed Channel Access Function (EDCAF) traffic types that includes background, best effort, video and voice.

In Example 22, the subject matter of one or any combination of Examples 16-21, wherein the starting CW size may be restricted to a group of candidate CW sizes that includes 3, 7, 15, 31, 63, 127, and 255.

In Example 23, the subject matter of one or any combination of Examples 16-22, wherein the transmission of the data signal may be delayed by the back-off count in accordance with a carrier sense multiple access with collision avoidance (CSMA/CA) protocol.

In Example 24, a method of contention based data transmission at an originating STA may comprise detecting an idle period of a current time block. The method may further comprise determining a back-off count to be used by the originating STA for contention based access for a Neighborhood Awareness Network Data Link (NDL) with a destination STA during the current time block. The method may further comprise transmitting a data signal to the destination STA during the current time block, the transmission of the data signal delayed by at least the back-off count with respect to an ending time of the idle period. The back-off count may be based at least partly on a previous back-off count used by the originating STA for contention based access for the NDL during a previous time block.

In Example 25, the subject matter of Example 24, wherein the determination of the back-off count to be used in the current time block may include carrying over at least a remaining portion of the previous back-off count to be used as the back-off count in the current time block.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus for a station (STA) configurable to operate as an originating STA, the apparatus comprising transceiver circuitry and hardware processing circuitry, configured to:
determine a starting contention window (CW) size to be used by the originating STA for contention based access for a Neighborhood Awareness Network Data Link (NDL) with a destination STA during a current time block;
detect an idle period of the current time block;
select a back-off count according to the starting CW size; and
transmit a data signal to the destination STA during the current time block, the transmission of the data signal delayed by at least the back-off count with respect to an ending time of the idle period,
wherein the starting CW size is determined based at least partly on a final CW size used by the originating STA for contention based access for the NDL during a previous time block.

2. The apparatus according to claim 1, wherein the detection of the idle period and the transmission of the data signal are performed in accordance with a carrier sense multiple access with collision avoidance (CSMA/CA) protocol.

3. The apparatus according to claim 1, wherein:
the starting CW size and the final CW size are restricted to a group that includes integer values of a form in which an exponentiation of a base value of two by an integer exponent is decremented by an integer value of one, and
the integer exponent is greater than an integer value of one.

4. The apparatus according to claim 1, wherein the data signal is transmitted to the destination STA over a direct wireless link between the originating STA and the destination STA and in accordance with a Neighborhood Awareness Network (NAN) protocol.

5. The apparatus according to claim 1, wherein the determination of the starting CW size includes carrying over the final CW size from the previous time block for usage as the starting CW size.

6. The apparatus according to claim 1, wherein:
the data signal is transmitted as part of a first chronological data signal transmission of a group of one or more data signal transmissions performed by the originating STA during the current time block, and
the starting CW size is determined for usage as part of the first chronological data signal transmission of the group.

7. The apparatus according to claim 6, wherein:
the group of data signal transmissions is a first group of data signal transmissions, and
the final CW size for the previous time block is used, by the originating STA, as part of a last chronological data signal transmission of a second group of one or more data signal transmissions performed by the originating STA during the previous time block.

8. The apparatus according to claim 1, wherein the current time block and the previous time block are included in a sequence of time blocks allocated at least partly for a Neighborhood Awareness Network (NAN) communication between the originating STA and one or more other STAs.

9. The apparatus according to claim 8, the transceiver circuitry and the hardware processing circuitry configured to:
determine, based at least partly on a synchronization signal received from another STA, a reference timing for the NAN communication,
wherein the time blocks in the sequence are based at least partly on the reference timing.

10. The apparatus according to claim 8, wherein the previous time block used in the determination of the starting CW size is restricted to a time block in the sequence for which a channel used by the originating STA is the same as a channel used by the originating STA during the current time block.

11. The apparatus according to claim 8, the transceiver circuitry and the hardware processing circuitry further configured to:
transmit, during a discovery window (DW) prior to the sequence of time blocks, a NAN management frame or a service discovery frame (SDF) that indicates a further availability window (FAW); and
transmit, during the FAW, a scheduling message for the NAN communication,
wherein the scheduling message is transmitted in accordance with an FAW CW size that is independent of the starting CW size for the current NDL time block and the final CW size for the previous time block.

12. The apparatus according to claim 8, wherein the starting CW size is further determined at least partly based on a determined number of data transmissions by other STAs during the previous time block or on a determined number of STAs that have established an NDL with the originating STA.

13. The apparatus according to claim 1, wherein:
the data signal is based on one or more data packets,
the starting CW size is further based at least partly on a traffic type of the data packets, and
the traffic type of the data packets is one of a group of Enhanced Distributed Channel Access Function (EDCAF) traffic types that includes background, best effort, video and voice.

14. The apparatus according to claim 1, wherein:
the idle period is a first idle period, the data signal is a first data signal, and the back-off count is a first back-off count,
the transceiver circuitry and the hardware processing circuitry are further configured to:
determine a successful reception indicator for the first data signal based on an attempted reception of an acknowledgement message from the destination STA for the first data signal;
determine a second CW size based on the successful reception indicator and further based on the starting CW size;
detect a second idle period during the current time block, wherein the second idle period occurs after the end of the transmission of the first data signal;
randomly select a second back-off count according to the second CW size; and
transmit a second data signal during the current time block, the transmission of the second data signal delayed by at least the second back-off count with respect to an ending time of the second idle period.

15. The apparatus according to claim 1, wherein the hardware processing circuitry includes baseband circuitry to determine the starting CW size.

16. A non-transitory computer-readable storage medium that stores instructions for execution by one or more processors to perform operations for channel based contention by a station (STA) configurable to operate as an originating STA, the operations to configure the one or more processors to:
determine, for a current time block, a starting contention window (CW) size based at least partly on a number of STAs included in a Neighborhood Awareness Network Data Cluster (NDC) that includes the originating STA; and
configure the originating STA to transmit, to a destination STA included in the NDC, a data signal delayed by a back-off count with respect to an idle period of the current time block, wherein the back-off count is selected randomly in accordance with the starting CW size;
wherein the data signal is transmitted as part of a first chronological data transmission of a group of one or more data transmissions by the originating STA during the current time block.

17. The non-transitory computer-readable storage medium according to claim 16, wherein:
the data signal is transmitted as part of a first chronological data signal transmission of a group of one or more data signal transmissions performed by the originating STA during the current time block, and
the starting CW size is determined for usage as part of the first chronological data signal transmission of the group.

18. The non-transitory computer-readable storage medium according to claim 16, wherein:
the current time block is included in a sequence of time blocks allocated at least partly for a Neighborhood Awareness Network (NAN) communication between the STAs in the NDC,
the time blocks in the sequence are synchronized in accordance with a reference timing for the NAN communication.

19. The non-transitory computer-readable storage medium according to claim 18, wherein the operations further configure the one or more processors to determine the reference timing based at least partly on a signal received from another STA.

20. The non-transitory computer-readable storage medium according to claim 18, the operations to further configure the one or more processors to configure the originating STA to:
transmit, during a discovery window (DW) prior to the sequence of time blocks, a NAN management frame or a service discovery frame (SDF) that indicates a capability of the originating STA for NDL operation; and
transmit, during a further availability window (FAW) subsequent to the DW and prior to the sequence of time blocks, a scheduling message for the NAN communication,
wherein the scheduling message is transmitted in accordance with an FAW CW size that is independent of the starting CW size for the time block.

21. The non-transitory computer-readable storage medium according to claim 16, wherein:
the data signal is based on one or more data packets,
the starting CW size is further based at least partly on a traffic type of the data packets, and
the traffic type of the data packets is one of a group of Enhanced Distributed Channel Access Function (EDCAF) traffic types that includes background, best effort, video and voice.

22. The non-transitory computer-readable storage medium according to claim 16, wherein the starting CW size is restricted to a group of candidate CW sizes that includes 3, 7, 15, 31, 63, 127, and 255.

23. The non-transitory computer-readable storage medium according to claim 16, wherein the transmission of the data signal is delayed by the back-off count in accordance with a carrier sense multiple access with collision avoidance (CSMA/CA) protocol.

24. A method of contention based data transmission at a station (STA) configurable to operate as an originating STA, the method comprising:
detecting an idle period of a current time block;
determining a back-off count to be used by the originating STA for contention based access for a Neighborhood Awareness Network Data Link (NDL) with a destination STA during the current time block,
transmitting a data signal to the destination STA during the current time block, the transmission of the data signal delayed by at least the back-off count with respect to an ending time of the idle period,
wherein the back-off count is based at least partly on a previous back-off count used by the originating STA for contention based access for the NDL during a previous time block.

25. The method according to claim 24, wherein the determination of the back-off count to be used in the current time block includes carrying over at least a remaining portion of the previous back-off count to be used as the back-off count in the current time block.
